(19) United States
(12) Patent Application Publication
(10) Pub. No.: US 2003/0014137 A1
(43) Pub. Date: Jan. 16, 2003

(54) Method and system for selecting a set of filter coefficients in a build-to-order computer system

(76) Inventors: Stephanus Saputro, Austin, TX (US); Rossana Ku, Austin, TX (US)

Correspondence Address: HAYNES AND BOONE, LLP, 901 MAIN STREET, SUITE 3100, DALLAS, TX, 75202, US

(21) Appl. No.: 09/906,630

(22) Filed: Jul. 16, 2001

(51) Int. Cl. G06F 17/00

(52) U.S. Cl. 700/94

(57) ABSTRACT

A system and method that include reading a first identifier associated with a first audio output device from a memory location, selecting a first set of filter coefficients associated with the first identifier, and providing the first set of filter coefficients to an audio generation module for use with the first audio output device are provided.

This application relates to co-pending U.S. patent application Ser. No. 09/333,786, filed on May 20, 1999, entitled “Method and Apparatus for Windows-Based Installation for Installing Software on Build-to-Order Computer Systems”, naming Bobby G. Doran, Jr., Bill Hyden, and Terry Wayne Liles as inventors.

This application relates to co-pending U.S. patent application Ser. No. 09/333,786, filed on Jun. 15, 1999, entitled “Method and Apparatus for Testing Custom-Configured Software/Hardware Integration in a Computer Build-to-Order Manufacturing Process”, naming Thomas Vrhel Jr., Gaston M. Barajas, Paul J. Maia, and W. D. Todd Nix as inventors.

### BACKGROUND

The disclosures herein relate generally to computer systems and more particularly to a method and system for selecting a set of filter coefficients in a build-to-order computer system.

The co-pending applications are incorporated by reference in their entirety, and are assigned to the assignee of this application.

Audio generation modules in computer systems typically include digital active band pass filters that can be adjusted from a single-stage filter to multi-stage filter. Audio generation modules that include these filters may be implemented in hardware, such as sound cards or sound devices integrated into a motherboard, or in software, such as audio drivers, or in some combination of hardware and software. Similarly, the filters may be implemented in hardware, software, or some combination of hardware and software.

Band pass filters operate according to a filter transfer function 100, T(s), as illustrated in FIG. 1. Filter transfer function 100 generates output signals 104 in response to input signals 102. Input signals 102 and output signals 104 are typically represented as voltages and are shown in FIG. 1 as Vᵢₙ and Vₒᵤₜ, respectively. In transfer function 100, a_{M} and a_{M-1} though a₀, and b_{N-1} though B₀ represent filter coefficients where N represents the order or stage of the filter.

One measure of the quality of sound produced by audio output devices such as speakers or other devices configured to produce sounds is the signal to noise ratio of the device. In order to optimize the signal-to-noise ratio performance of an audio output device, an audio generation module uses a set of filter coefficients that are optimized for use with a particular audio output device and/or computer system.

It would be desirable for a computer system to be able to select a set of filter coefficients associated with an audio output device to allow the sound quality of the audio output device to be optimized. Accordingly, what is needed is a method and system for selecting a set of filter coefficients in a build-to-order computer system.

### SUMMARY

One embodiment, accordingly, provides a system and method that include reading a first identifier associated with a first audio output device from a memory location, selecting a first set of filter coefficients associated with the first identifier, and providing the first set of filter coefficients to an audio generation module for use with the first audio output device.

A principal advantage of this embodiment is that it overcomes disadvantages of previous techniques. For example, it may allow the sound quality of an audio output device associated with a computer system to be optimized without the need for intervention on the part of a user of the computer system.

### BRIEF DESCRIPTION OF THE DRAWINGS

FIG. 1 is a diagram illustrating an embodiment of a filter transfer function.

FIG. 2 is a diagram illustrating an embodiment of selected portions of a computer system configured to select filter coefficients for use with an audio output device.

FIG. 3 is a flow chart illustrating an embodiment of a method for selecting filter coefficients for a computer system.

### DETAILED DESCRIPTION

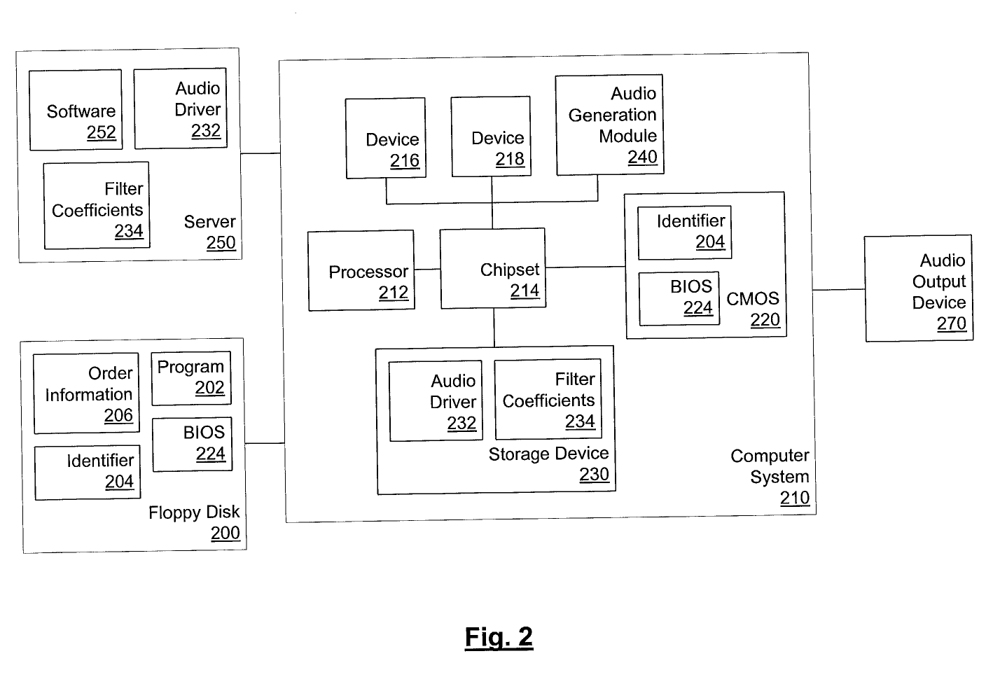

FIG. 2 is a diagram illustrating an embodiment of selected portions of a computer system 210 configured to select filter coefficients for use with an audio output device 270 coupled to computer system 210. Computer system 210 includes a processor 212, a chipset 214, a device 216, a device 218, a CMOS 220, a storage device 230, and an audio generation module 240. CMOS 220 is one example of a non-volatile storage device that may be included in computer system 210. Other embodiments of computer system 210 may include other types of non-volatile storage devices.

In the embodiment shown in FIG. 2, computer system 210 is configured to access information and communicate with a floppy disk 200 and a server 250. Floppy disk 200 includes a program 202, an identifier 204, order information 206, and a basic input output system (BIOS) 224. Server 250 includes software 252 and audio driver 232.

Computer system 210 is manufactured according to a build-to-order manufacturing process. In this process, an order for computer system 210 is received that specifies hardware and software components of computer system from a customer. Computer system 210 is assembled by a computer manufacturer to include each of the hardware and software components specified by the customer. One of the hardware components specified by a customer as part of an order for computer system 210 may be audio output device 270. Audio output device 270 may be any type of device capable of producing sounds such as speakers.

As part of the process of assembling computer system 210, program 202, identifier 204, order information 206, and BIOS 224 are copied onto floppy disk 200. Floppy disk 200 is includes as part of a traveler that accompanies computer system 210 through various stages of the manufacturing process. Floppy disk 200 is one example of media configured to store information that is accessible by computer system 210. Other examples of such media include a CD-ROM device, a hard disk drive, or other media that may be directly coupled to computer system 210 as well as a storage device coupled to a computer system located remotely from computer system 210.

After the hardware components of computer system 210 are assembled and installed, computer system 210 boots using floppy disk 200. In particular, program 202 causes BIOS 224 to be copied or flashed onto CMOS 220. BIOS 224 includes instructions configured to cause computer system 210 to be booted. BIOS 224 may cause components in computer system 210 to be initialized as part of a boot process. In other embodiments, a system firmware may be substituted in place of BIOS 224 and may perform functions similar to those of BIOS 224 described herein.

Program 202 also causes software specified by the customer to be installed onto computer system 210 using order information 206. In the embodiment shown in FIG. 2, program 202 causes software components identified in order information 206 to be accessed on server 250 and installed onto computer system 210. Software 252 on server 250 represents a set of software components, such as operating systems, device drivers, applications, and other software, that may be installed onto computer system 210. After all hardware and software components of computer system 210 are installed and tested, computer system 210 may be provided to the customer.

Computer system 210 is configured to operate in conjunction with audio output device 270. In particular, audio generation module 240 or other devices in computer system 210 generate audio signals and provide the audio signals to audio output device 270. In response to the audio signals, audio output device 270 produces sounds, music, or other noises associated with the audio signals. Audio generation module 240 includes a digital active band pass filters that can be adjusted from a single-stage filter to multi-stage filter. Audio generation module 240 may be implemented in hardware, such as a sound card or a sound device integrated into a motherboard of computer system 210, or in software, such as an audio or video driver, or in some combination of hardware and software. Although shown separately from audio driver 232 in FIG. 2, audio generation module 240 may be implemented in software as a part of audio driver 232 in other embodiments.

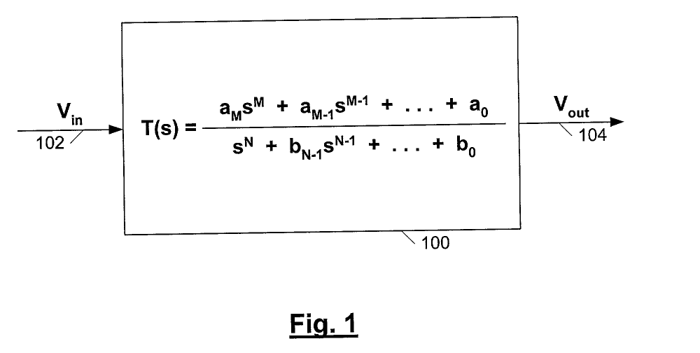

The band pass filters in audio generation module 240 operates according to a filter transfer function such as filter transfer function 100, T(s), as illustrated in FIG. 1. As noted above, filter transfer function 100 generates output signals 104 in response to input signals 102. Input signals 102 and output signals 104 are typically represented as voltages and are shown in FIG. 1 as Vᵢₙ and Vₒᵤₜ, respectively. In transfer function 100, a_{M} and a_{M-1} though a₀, and b_{N-1} though B₀ represent filter coefficients where N represents the order or stage of the filter.

In order to optimize the performance of an audio output device 270, audio generation module 240 uses a set of filter coefficients that are optimized for use with audio output device 270. This set of filter coefficients includes one or more filter coefficient values that may be provided by a manufacturer or developer of audio generation module 240 and included in computer system 210.

A customer may select audio output device 270 from a set of audio output devices offered by a manufacturer or vendor of computer system 210. Accordingly, the manufacturer or vendor of computer system 210 may provide a set of filter coefficients that are an optimized set of values for use with the audio output device 270 selected by the customer. In order to provide a set of coefficients that are optimized for a particular audio output device 270, the set of coefficients is selected for use by audio generation module 240 using the system of FIG. 2.

In the system of FIG. 2, identifier 204 is stored onto floppy disk 200. Identifier 204 is associated with a particular audio output device 270 ordered by a customer. Identifier 204 may be any numerical or alphanumeric value that identifies one of a set of audio output devices. BIOS 224 includes instructions configured to cause identifier 204 to be stored in a known register or memory location in CMOS 220. In other embodiments, identifier 204 may be stored in other memory locations on computer system 210.

As part of the software installation process described above, program 202 causes audio driver 232 and filter coefficient file 234 to be installed onto computer system 210. Audio driver 232 and filter coefficient file 234 are shown in storage device 230. Audio driver 232 includes instructions that provide audio generation module 240 with the ability to operate in conjunction with computer system 210 and provide signals to audio output device 270. Filter coefficients file 234 includes a set of filter coefficients for each of a set of audio output devices that are configured to operate in conjunction with computer system 210. Accordingly, filter coefficient file 234 includes plurality of sets of filter coefficients. Each set of coefficients includes one or more values for use with the bandpass filter included in audio generation module 240. For example, filter coefficient file 234 may include a list that includes a set of identifiers that each have a set of filter coefficients.

After identifier 204, audio driver 232, and filter coefficient file 234 are stored onto computer system 210, the set of filter coefficients in filter coefficient file 234 associated with an audio output device 270 ordered by a customer are selected for use with audio generation module 240. Audio driver 232 includes instructions configured to cause identifier 204 to be detected and read. Audio driver 204 causes a set of filter coefficients to be selected from filter coefficient file 234 using identifier 204. Audio driver 232 then causes the selected set of filter coefficients to be provided to audio generation module 240 for use with audio output device 270. The selected set of filter coefficients may be stored in a memory location identified by audio generation module 240. As noted above, audio generation module 240 may be included in audio driver 232 in certain embodiments. In these embodiments, audio driver 232 provides the set of filter coefficients to audio generation module 240 by passing them to one or more software modules in audio generation module 240.

In this manner, a set of coefficients optimized for use with a particular audio output device 270 ordered by a customer may be provided in computer system 210 without the need for the customer to separately select or set the filter coefficients after computer system 210 is received.

Although the functions described above have been described with reference to a particular software module such as BIOS 224 or audio driver 232, each function or parts of each function may be performed by a different software module in other embodiments. For example, a program other than BIOS 224 may cause identifier 204 to be stored onto computer system 210. Similarly, a program other than audio driver 232 may cause a set of filter coefficients to be selected using identifier 204 and/or provided to audio generation module 240.

In addition, identifier 204 and filter coefficient file 234 may be stored in and accessed from memory locations remote from computer system 210 in other embodiments. For example, identifier 204 and filter coefficient file 234 may be stored remotely from computer system 210, e.g. on server 250, and accessed or selected from the remote location.

Further, the sets of coefficients stored in filter coefficient file 234 may be included as part of audio driver 232 or stored in two or more different files in other embodiments. For example, each set of coefficients may be stored in a separate file. These two or more different files may be stored on computer system 210 and/or remotely from computer system 210.

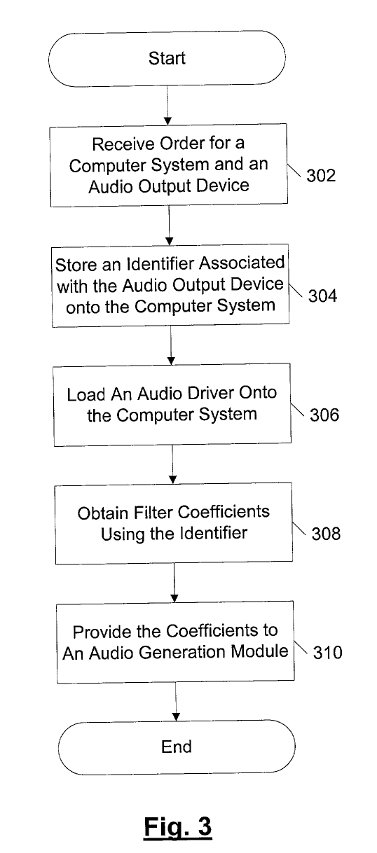

FIG. 3 is a flow chart illustrating an embodiment of a method for selecting filter coefficients for a computer system. In FIG. 3, an order for a computer system and an audio output device is received as indicated in step 302. An identifier associated with the audio output device is stored onto the computer system as indicated in step 304. An audio driver is loaded onto the computer system as indicated in step 306. Filter coefficients are obtained using the identifier as indicated in step 308. The filter coefficients are provided to an audio device as indicated in step 310.

As can be seen, the principal advantages of these embodiments are that they overcome disadvantages of previous techniques. For example, they may allow the sound quality of an audio output device associated with a computer system to be optimized without the need for intervention on the part of a user of the computer system.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A system comprising:
a computer system for:
reading a first identifier associated with a first audio output device from a memory location;
selecting a first set of filter coefficients associated with the first identifier; and
providing the first set of filter coefficients to an audio generation module for use with the first audio output device.

2. The system of claim 1, wherein the computer system is for:
prior to reading the first identifier from the memory location, receiving the first identifier from media coupled to the computer system; and
prior to reading the first identifier from the memory location, storing the first identifier in the memory location.

3. The system of claim 2, wherein the media comprises a floppy disk.

4. The system of claim 2, wherein the media comprises a storage device located remotely from the computer system.

5. The system of claim 2, wherein the computer system includes a storage device, and wherein the storage device includes the memory location.

6. The system of claim 5, wherein the storage device comprises a non-volatile storage device.

7. The system of claim 2, wherein the computer system includes a basic input output system (BIOS), and wherein the BIOS includes instructions configured to cause the computer system to:
receive the first identifier from the media coupled to the computer system; and
store the first identifier in the memory location.

8. The system of claim 1, wherein the computer system includes a first file, wherein the first file includes the first set of filter coefficients, and wherein the computer system is for selecting the first set of filter coefficients from the first file.

9. The system of claim 8, wherein the first file includes a second set of filter coefficients associated with a second audio output device.

10. The system of claim 8, wherein the computer system includes a second file, and wherein the second file includes a second set of filter coefficients associated with a second audio output device.

11. The system of claim 1, wherein the computer system is for selecting the first set of filter coefficients from a file located remotely from the computer system.

12. The system of claim 1, wherein the computer system includes an audio driver, and wherein the audio driver includes instructions configured to cause the computer system to:
select the first set of filter coefficients associated with the first identifier; and
provide the first set of filter coefficients to the audio generation module for use with the first audio output device.

13. A method performed by a computer system that includes an audio generation module comprising:
reading a first identifier associated with a first audio output device from a memory location;
selecting a first set of filter coefficients associated with the first identifier; and
providing the first set of filter coefficients to the audio generation module for use with the first audio output device.

14. The method of claim 13, further comprising:
prior to reading the first identifier from the memory location, receiving the first identifier from media coupled to the computer system; and
prior to reading the first identifier from the memory location, storing the first identifier in the memory location.

15. The method of claim 14, further comprising:
prior to reading the first identifier from the memory location, receiving the first identifier from the media coupled to the computer system, the media including a floppy disk.

16. The method of claim 14, further comprising:
prior to reading the first identifier from the memory location, receiving the first identifier from the media coupled to the computer system, the media including a storage device located remotely from the computer system.

17. The method of claim 13, further comprising:
selecting the first set of filter coefficients from a file located in the computer system.

18. The method of claim 13, further comprising:
selecting the first set of filter coefficients from a file located remotely from the computer system.

19. A system comprising:
a computer system including an audio generation module;
media accessible by the computer system, the media including an identifier associated with one of plurality of audio output devices;
the computer system configured to:
read the identifier from the media;
select one of a plurality of sets of filter coefficients, the one of the plurality of sets of filter coefficients associated with the identifier; and
provide the one of the plurality of sets of filter coefficients to the audio generation module for use with the one of the plurality of audio output devices.

20. The system of claim 19, wherein the computer system is configured to:
store the identifier in a memory location on the computer system prior to reading the identifier from the media.

21. The system of claim 20, wherein the media comprises a floppy disk.

22. The system of claim 20, wherein the media comprises a storage device located remotely from the computer system.

23. The system of claim 20, wherein the computer system includes a storage device, and wherein the storage device includes the memory location.

24. The system of claim 23, wherein the storage device comprises a non-volatile storage device.

25. The system of claim 19, wherein the computer system includes a basic input output system BIOS, and wherein the BIOS includes instructions configured to cause the computer system to:
receive the first identifier from the media; and
store the first identifier in a memory location on the computer system.

26. The system of claim 19, wherein the computer system includes a file, wherein the file includes the plurality of sets of filter coefficients, and wherein the computer system is configured to select the one of the plurality of sets of filter coefficients from the file.

27. The system of claim 19, wherein the computer system is configured to select the one of the plurality of sets of filter coefficients from a file located remotely from the computer system.

28. The system of claim 19, wherein the computer system includes an audio driver, and wherein the audio driver includes instructions configured to cause the computer system to:
select the one of the plurality of sets of filter coefficients; and
provide the one of the plurality of sets of filter coefficients to the audio generation module for use with the first audio output device.
